(19) United States
(12) Patent Application Publication
(10) Pub. No.: US 2026/0254942 A1
(43) Pub. Date: Aug. 27, 2026

(54) REINFORCEMENT LEARNING-BASED LAMBDA FACTOR DERIVATION FOR ENHANCED MODE DECISION IN VIDEO CODECS

(71) Applicant: NVIDIA Corporation, Santa Clara, CA (US)

(72) Inventors: Satish Kumar Suman, Ranchi (IN); Sampurnananda Mishra, Pune (IN)

(21) Appl. No.: 19/064,187

(22) Filed: Feb. 26, 2025

(51) Int. Cl. H04N 19/105; H04N 19/159; H04N 19/176

(52) U.S. Cl. CPC H04N 19/105; H04N 19/159; H04N 19/176

(57) ABSTRACT

Systems and methods for improving video encoding. Systems and methods are provided for performing video encoding using a dynamically determined weighting parameter that balances rate and distortion tradeoffs. In at least one embodiment, a neural network is trained using reinforcement learning to dynamically determine the weighting parameter that balances rate and distortion tradeoffs.

### FIELD

The present disclosure relates to video encoding and, in particular, to video encoding using a dynamically determined weighting parameter that balances rate and distortion tradeoffs. In at least one embodiment, a neural network is trained using reinforcement learning to dynamically determine the weighting parameter that balances rate and distortion tradeoffs.

### BACKGROUND

Video compression reduces the size of digital video files while simultaneously limiting distortion to maintain visual quality. In recent years, on-demand video playback and video streaming services have proliferated due to advances in compression, computing, and network and data transport infrastructure technologies. Video content now accounts for more than 80% of all consumer Internet traffic—a number that is expected to increase over the following years. Bandwidth reduction achieved by video compression has therefore become crucial for reducing network traffic to satisfy consumer demand.

The video compression process typically begins by obtaining input in the form of a video (which includes a sequence of images, or frames) and dividing each frame into a plurality of smaller blocks. Algorithms identify redundancies between different frames (to provide for temporal compression) and within individual frames (to provide for spatial compression). Once identified, temporal and spatial redundancies can be removed or simplified, enabling the remaining data to be efficiently encoded.

In order to exploit temporal and spatial redundancies for the purpose of compression, many techniques rely on both inter- and intra-frame prediction. In inter-frame prediction, a predictor estimates frame content based on a previous frame or frames, and a corrector determines a difference between the estimated frame content and the actual frame content, i.e., frame correction values. In intra-frame prediction, a predictor estimates pixels based on, e.g., neighboring pixels, and a corrector determines a difference between the estimated pixels and the actual pixel values, i.e., pixel correction values. Compression is achieved by encoding only the frame correction values (for inter-frame prediction) and pixel correction values (for intra-frame prediction). The original video can then be reconstructed by estimating frames and pixels in the same manner and then correcting them with decoded frame correction values and pixel correction values.

In order to determine a prediction mode for individual frames and/or blocks thereof, video encoding techniques consult a joint rate-distortion cost function to maintain a balance between rate and distortion. The joint rate-distortion cost function is represented J=D+λR, where D represents distortion, R represents rate, and λ is a Lagrange multiplier (i.e., a weighting parameter) that maintains a balance between rate and distortion.

### BRIEF DESCRIPTION OF THE DRAWINGS

The present systems and methods for and video acquisition and processing are described in detail below with reference to the attached drawing figures, wherein:

FIG. 1A is a block diagram illustrating a system, according to an embodiment, for encoding video content using a dynamically determined weighting parameter;

FIG. 1B is a flow diagram illustrating a process, according to an embodiment, for selecting, using a dynamically determined weighting parameter, a candidate predicted image block for use in a downstream encoding process;

FIG. 2A is a block diagram illustrating a system for training a neural network to dynamically determine a weighting parameter that balances rate and distortion during video encoding;

FIG. 2B is a flow diagram illustrating a process, according to an embodiment, for training a neural network to dynamically determine a weighting parameter that balances rate and distortion during video encoding;

FIG. 3 is a block diagram illustrating a reinforcement learning framework for training a neural network;

FIG. 4 is a conceptual diagram of a processing system implemented using a PPU, suitable for use in implementing some embodiments of the present disclosure;

FIG. 5A illustrates an exemplary system in which the various architecture and/or functionality of the various previous embodiments may be implemented;

FIG. 5B illustrates components of an exemplary system that can be used to train and utilize machine learning, in at least one embodiment; and

FIG. 6 illustrates an exemplary streaming system suitable for use in implementing some embodiments of the present disclosure.

### DETAILED DESCRIPTION

The present disclosure provides systems and methods for improving video encoding. Systems and methods are provided for performing video encoding using a dynamically determined weighting parameter that balances rate and distortion tradeoffs. In at least one embodiment, a neural network is trained using reinforcement learning to dynamically determine the weighting parameter that balances rate and distortion tradeoffs. In at least one embodiment, the weighting parameter is determined based on encoding of one or more prior frames and/or based on video content to be encoded. In at least one embodiment, the dynamically determined weighting parameter dynamically tunes a joint rate-distortion cost function during video encoding to improve video compression quality (i.e., to provide improved quality given a fixed bitrate or to provide reduced bitrate given a fixed video quality).

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles, semi-autonomous vehicles (e.g., in one or more advanced driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations, systems implemented using large language models (LLMs), systems implemented using vision language models (VLMs), systems for performing light transport simulation, systems for performing collaborative content creation for 3D assets, systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs) —which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods provided by the present disclosure provide novel techniques related to video encoding. In at least one embodiment, the present disclosure provides a learned neural network, trained via reinforcement learning, for dynamically determining, for one or more frames (e.g., each frame) of a video to be encoded, a weighting parameter that balances rate and distortion during video encoding. In at least one embodiment, the present disclosure provides for training a neural network, using reinforcement learning, to dynamically determine, for one or more frames (e.g., each frame) of a video to be encoded, a weighting parameter that balances rate and distortion during video encoding. In at least one embodiment, the present disclosure provides for encoding video content using a weighting parameter that balances rate and distortion, wherein the weighting parameter is dynamically determined based on encoding of prior frames and/or based on the video content. The use of a dynamically determined weighting parameter (e.g., as determined by a trained RL agent from state information corresponding to the encoding of a prior frame) for video encoding has demonstrated a substantial BD-rate improvement (i.e., Bjontegaard Delta Rate, a measure of the bitrate reduction achieved while maintaining the same quality) as compared with the use of a static Lagrangian multiplier (e.g., as empirically determined for a particular off-the-shelf video codec) for video encoding. According to at least one embodiment, a BD-rate improvement of more than 15% has been demonstrated via the use of the dynamically determined weighting parameter described herein.

A method is provided herein for encoding a video. The method includes determining a weighting parameter for a frame of the video by a trained reinforcement learning (RL) agent. The weighting parameter is determined based on results of encoding of one or more prior frames of the video. The method further includes generating, for a reference block of a frame of the video, a plurality of candidate predicted blocks and selecting, using rate-distortion optimization (RDO) based on the determined weighting parameter to balance rate and distortion components of a joint loss function, a predicted block from the plurality of candidate predicted blocks.

According to an embodiment, the method further includes computing, using the selected predicted block and the reference block, residuals and encoding the residuals in a codestream.

According to an embodiment of the method, the joint loss function is J=D+(λ_{f}*λ)*R, where D represents distortion, R represents rate, λ_{f} is the weighting parameter determined by the trained RL agent, and λ is an empirically determined Lagrange multiplier. According to an alternative embodiment of the method, the joint loss function is J=D+λ_{f}R, where D represents distortion, R represents rate, and λ_{f} is the weighting parameter determined by the trained RL agent.

According to an embodiment of the method, the encoding one or more prior frames of the video comprises encoding statistics corresponding to the encoding of one or more previously encoded video frames. According to an embodiment, the encoding statistics include one or more of: a bitstream size, an average Quantization Parameter (QP) value for one or more frames, a count of intra-coded macroblocks, a count of inter-coded macroblocks, a number of slices, a picture type, a Sum of Absolute Transformed Differences (SATD) for one or more frames, an average Motion Vector (MV) x-component, an average Motion Vector (MV) y-component, a count of 32×32 coding units (CUs) encoded using intra-prediction, a count of 32×32 CUs encoded using inter-prediction, a count of 16×16 CUs encoded using intra-prediction, a count of 16×16 CUs encoded using inter-prediction.

According to an embodiment of the method, the trained RL agent is a trained neural network comprising one or more layers of Long Short-Term Memory (LSTM) units. According to an embodiment, the trained RL agent is a neural network trained via proximal policy optimization (PPO). According to an embodiment, the RL agent is a neural network trained, via reinforcement learning, to maximize a reward based on encoding performance. According to an embodiment, the reward is computed using an advantage function that measures an advantage achieved by encoding the frame using the weighting parameter as compared to encoding the frame without using the weighting parameter.

According to an embodiment of the method, the plurality of candidate predicted blocks are generated by an intra-frame predictor and an inter-frame predictor, at least one of the plurality of candidate predicted blocks is predicted in accordance with a combination of or more prediction parameters, and the combination of one or more prediction parameters include at least one of: a prediction mode, a partition mode, a coding mode, a skip mode, a reference frame selection, a chroma subsampling mode, a strength of one or more filters.

According to an embodiment of the method, the encoding is performed using an off-the-shelf video codec being one of: H.264, HEVC, AV1, AV2, or VVC.

A system is provided herein for encoding a video. The system includes processing circuitry configured to determine a weighting parameter for a frame of the video by a trained reinforcement learning (RL) agent. The weighting parameter is determined based on results of encoding of one or more prior frames of the video. The processing circuitry is further configured to generate, for a reference block of a frame of the video, a plurality of candidate predicted blocks and select, using rate-distortion optimization (RDO) based on the determined weighting parameter to balance rate and distortion components of a joint loss function, a predicted block from the plurality of candidate predicted blocks. The system further includes memory configured to store the frame and the plurality of candidate predicted blocks.

According to an embodiment of the system, the processing circuitry is further configured to compute, using the selected predicted block and the reference block, residuals and encode the residuals in a codestream.

According to an embodiment of the system, the joint loss function is J=D+(λ_{f}*λ)*R, where D represents distortion, R represents rate, λ_{f} is the weighting parameter determined by the trained RL agent, and λ is an empirically determined Lagrange multiplier. According to an alternative embodiment of the system, the joint loss function is J=D+λ_{f}R, where D represents distortion, R represents rate, and λ_{f} is the weighting parameter determined by the trained RL agent.

According to an embodiment of the system, the results of encoding one or more prior frames of the video comprise encoding statistics corresponding to the encoding of one or more previously encoded video frames. According to an embodiment, the encoding statistics include one or more of: a bitstream size, an average Quantization Parameter (QP) value for one or more frames, a count of intra-coded macroblocks, a count of inter-coded macroblocks, a number of slices, a picture type, a Sum of Absolute Transformed Differences (SATD) for one or more frames, an average Motion Vector (MV) x-component, an average Motion Vector (MV) y-component, a count of 32×32 coding units (CUs) encoded using intra-prediction, a count of 32×32 CUs encoded using inter-prediction, a count of 16×16 CUs encoded using intra-prediction, and/or a count of 16×16 CUs encoded using inter-prediction, etc.

According to an embodiment of the system, the trained RL agent is a trained neural network comprising one or more layers of Long Short-Term Memory (LSTM) units. According to an embodiment, the trained RL agent is a neural network trained via proximal policy optimization (PPO). According to an embodiment, the RL agent is a neural network trained, via reinforcement learning, to maximize a reward based on encoding performance. According to an embodiment, the reward is computed using an advantage function that measures an advantage achieved by encoding the frame using the weighting parameter as compared to encoding the frame without using the weighting parameter.

According to an embodiment of the system, the plurality of candidate predicted blocks are generated by an intra-frame predictor and an inter-frame predictor, at least one of the plurality of candidate predicted blocks being predicted in accordance with a combination of or more prediction parameters, and the combination of one or more prediction parameters include at least one of: a prediction mode, a partition mode, a coding mode, a skip mode, a reference frame selection, a chroma subsampling mode, or a strength of one or more filters.

According to an embodiment of the system, the encoding is performed using an off-the-shelf video codec being one of: VP8, VP9, AVC (h.264), HEVC (h.265), AV1, AV2, or VVC (h.266).

A system is provided herein that includes one or more processing units to determine a weighting parameter for a frame of a video, the weighting parameter being determined based on results of encoding of one or more prior frames of the video, to generate, for a reference block of a frame of the video, a plurality of candidate predicted blocks, and to select, using rate-distortion optimization (RDO) based on the determined weighting parameter to balance rate and distortion components of a joint loss function, a predicted block from the plurality of candidate predicted blocks.

According to an embodiment of the system, the one or more processing units are included in at least one of: a system for performing simulation operations; a system for performing simulation operations to test or validate autonomous machine applications; a system for performing digital twin operations; a system for performing light transport simulation; a system for rendering graphical output; a system for performing deep learning operations; a system implemented using an edge device; a system for generating or presenting virtual reality (VR) content; a system for generating or presenting augmented reality (AR) content; a system for generating or presenting mixed reality (MR) content; a system incorporating one or more Virtual Machines (VMs); a system implemented at least partially in a data center; a system for performing hardware testing using simulation; a system for synthetic data generation; a system for performing generative AI operations; a system implemented using one or more large language model (LLMs), a system implemented using one or more vision language model (VLMs); a collaborative content creation platform for 3D assets; or a system implemented at least partially using cloud computing resources.

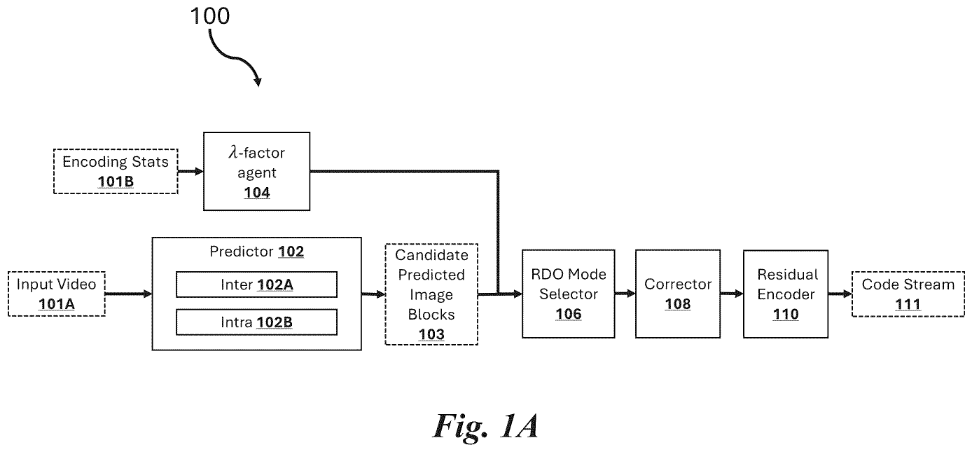

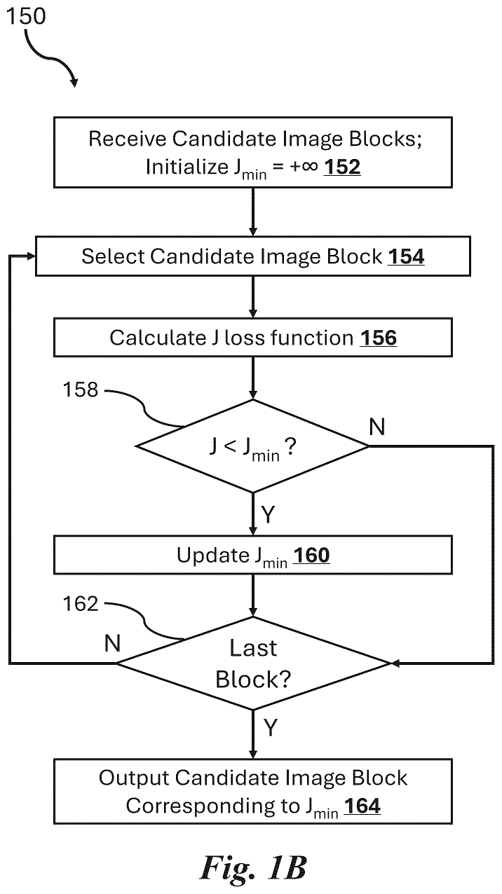

FIG. 1A provides a block diagram of an example system 100, according to an embodiment. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the example system 100 is within the scope and spirit of embodiments of the present disclosure.

System 100 encodes video content using, during rate-distortion optimization (RDO), a dynamically-determined weighting parameter that balances rate and distortion, wherein the weighting parameter is dynamically determined based on encoding of prior frames and/or the video content that is to be encoded. The system 100 includes a predictor 102, a λ-factor agent 104, a rate-distortion optimization (RDO) mode selector 106, a corrector 108, and residual encoder 110.

Predictor 102 receives an input video 101A and performs preprocessing of the input video 101A to produce candidate image blocks 103. Predictor 102 divides one or more frames (e.g., each frame) in the input video 101A into a plurality of macroblocks. The division is performed in accordance with an off-the-shelf video codec (e.g., VP8, VP9, AVC (h.264), HEVC (h.265), AV1, AV2, or VVC (h.266), etc.). Predictor 102 further provides, for one or more respective macroblocks (e.g., each macroblock), a plurality of candidate predicted image blocks for use in a downstream encoding process. At least one (e.g., each) of the plurality of candidate predicted image blocks is predicted in accordance with a unique combination of prediction parameters, which includes a prediction mode (i.e., intra-prediction or inter-prediction). For candidate predicted image blocks that specify the intra-prediction mode, additional specified prediction parameters can include, e.g., a macroblock partition mode and a directional mode. For candidate image blocks that specify the inter-prediction mode, one or more additional specified prediction parameters can include a macroblock partition mode, motion vector candidates, and reference frame indices. In at least one embodiment, the combination of prediction parameters include parameters specifying one or more of: a prediction mode, a partition mode, a coding mode, a skip mode, a reference frame selection, a chroma subsampling mode, and a strength of one or more filters. The candidate image blocks are output as candidate image blocks 103 and provided as input to the RDO mode selector 106.

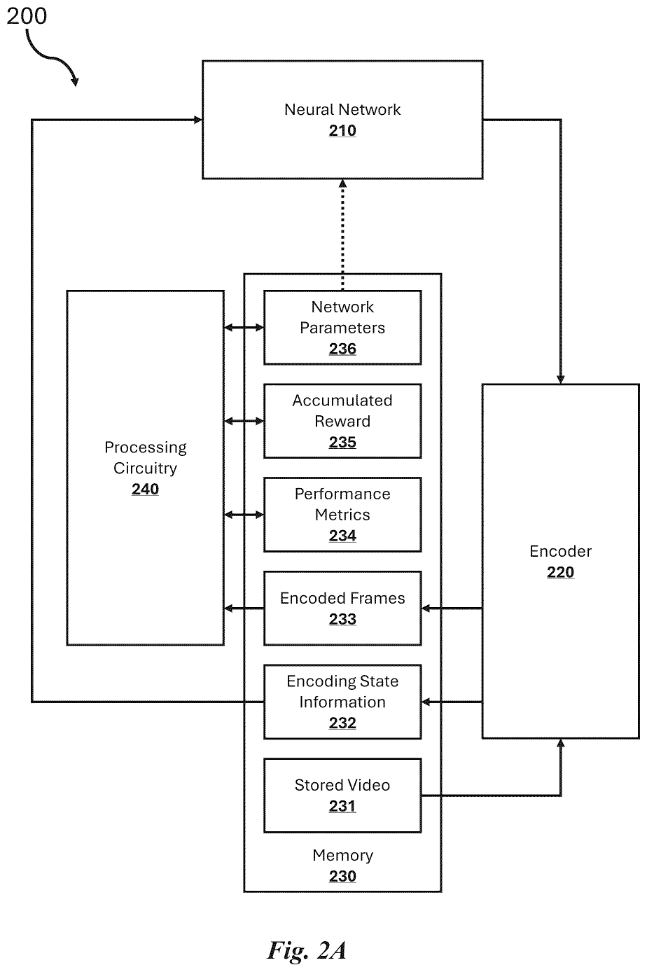

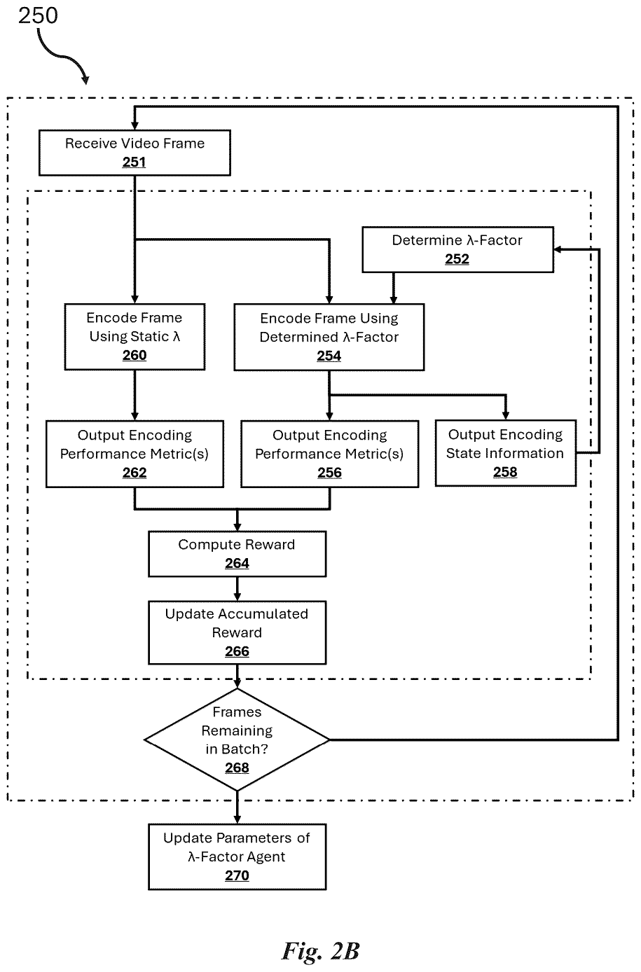

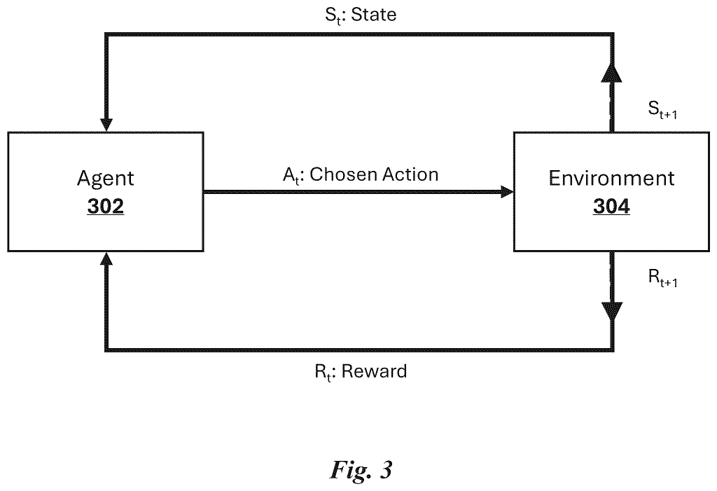

In one or more embodiments, λ-factor agent 104 receives encoding statistics 101B and determines, based thereon, a λ-factor utilized during video encoding. In at least one embodiment, encoding statistics 101B include, e.g., frame statistics, mode selection information, a combination of prediction parameters, etc. corresponding to the encoding of one or more previously encoded video frames. In at least one embodiment, encoding statistics 101B include one or more of a bitstream size (e.g., bitstreamSizeInBytes), an average Quantization Parameter (QP) value for one or more frames (e.g., frameAvgQP), a count of intra-coded macroblocks (e.g., intraMBCount), a count of inter-coded macroblocks (e.g., interMBCount), a number of slices (numSlices), a picture type (e.g., pictureType), a Sum of Absolute Transformed Differences (SATD) for one or more frames (e.g., frameSatd), an average Motion Vector (MV) x-component (e.g., averageMVX), an average Motion Vector (MV) y-component (e.g., averageMVY), a count of 32×32 coding units (CUs) encoded using intra-prediction (e.g., intra_cu32×32_count), a count of 32×32 CUs encoded using inter-prediction (e.g., inter_cu32×32_count), a count of 16×16 CUs encoded using intra-prediction (e.g., intra_cu16×16_count), and a count of 16×16 CUs encoded using inter-prediction (e.g., inter_cu16×16_count). In at least one embodiment, λ-factor agent 104 is a trained neural network (e.g., a neural network trained via the system illustrated in FIG. 2A, the process illustrated in FIG. 2B, and/or the framework illustrated in FIG. 3). In at least one embodiment, λ-factor agent 104 is a neural network trained via reinforcement learning. In at least one embodiment, the neural network is trained via proximal policy optimization (PPO). In at least one embodiment, the neural network is trained to predict a λ-factor that minimizes distortion for a given bitrate. In at least one embodiment, the neural network is trained to predict a λ-factor that minimizes bitrate for a given video playback quality. In at least one embodiment, the trained neural network includes one or more layers of Long Short-Term Memory (LSTM) units. In at least one embodiment, the trained neural network consists of 3 layers of LSTM units, each including 64 neurons. LSTM units are capable of capturing temporal dependencies and therefore suitable for video data, which includes temporal sequences of frames.

In one or more embodiments, RDO mode selector 106 selects, for one or more macroblocks (e.g., each macroblock), a single candidate image block (that specifies a unique combination of prediction parameters) from the plurality of candidate image blocks 103. The selection made by the RDO mode selector 106 is based on the λ-factor provided by λ-factor agent 104, which balances rate and distortion during video encoding to improve video compression quality (i.e., to provide improved quality given a fixed bitrate or to provide reduced bitrate given a fixed video quality). In at least one embodiment, rate and distortion are balanced during video encoding by minimizing a joint rate-distortion cost function J=D+(λ_{f}*λ)R, where D represents distortion, R represents rate, and λ is a Lagrange multiplier (i.e., a weighting parameter) that maintains a balance between rate and distortion, and λ_{f} is the λ-factor determined by λ-factor agent 104. The product λ_{f}*λ is therefore a dynamically determined (based on encoding of prior frames and/or the video content that is to be encoded) weighting parameter that balances rate and distortion in the RDO mode selection performed by RDO mode selector 106. In at least one such embodiment, the static weighting parameter λ is determined based on a quantization parameter of an off-the-shelf video codec. For example, in at least one embodiment, the static weighting parameter λ is selected from a fixed table of empirically derived values corresponding to selected quantization parameters of a particular off-the-shelf video codec. In at least one alternative embodiment, rate and distortion are balanced during video encoding by minimizing a joint rate-distortion cost function J=D+λ_{f}R, where D is a value of the distortion measure, R is a value of the bit rate measure, and λ_{f} is a dynamically determined λ-factor determined by λ-factor agent 104. In at least one embodiment, the RDO mode selector 106 selects the single predicted image block for the macroblock via the process illustrated in FIG. 1B.

Corrector 108 computes, using the predicted image block selected by RDO mode selector 106 and the corresponding macroblock of the frame of the input video 101A, residuals (i.e., correction values) between the predicted image block and the corresponding macroblock. Corrector 108 outputs the computed residuals, which are provided as input to the residual encoder 110. Residual encoder 110 encodes the residuals into code stream 111 (e.g., an encoded bitstream), which can then be transmitted, via a network, to a user device and/or stored in memory. The code stream 111 includes, in addition to the encoded residuals, an indication of a combination of prediction parameters (i.e., the prediction parameters in accordance with which the selected predicted image block is predicted) to enable a decoder to reconstruct the macroblock.

FIG. 1B is a flow diagram illustrating a process 150, according to an embodiment, for selecting, using a dynamically determined weighting parameter, a candidate predicted image block for use in a downstream encoding process. Each block of process 150, described herein, comprises a computing process that may be performed using any combination of hardware, firmware, and/or software. For instance, various functions may be carried out by a processor executing instructions stored in memory. The process may also be embodied as computer-usable instructions stored on computer storage media. The process may be provided by a standalone application, a service or hosted service (standalone or in combination with another hosted service), or a plug-in to another product, to name a few. In addition, process 150 is described, by way of example, with respect to the system of FIG. 1A. However, this process may additionally or alternatively be executed by any one system, or any combination of systems, including, but not limited to, those described herein. Furthermore, persons of ordinary skill in the art will understand that any system that performs process 150 is within the scope and spirit of embodiments of the present disclosure.

Process 150 is a process for selecting, by an RDO mode selector (e.g., RDO mode selector 106) for use in a downstream encoding process (e.g., the encoding process performed by the corrector 108 and the residual encoder 110), a single candidate predicted image block (e.g., one of candidate predicted image blocks 103) for a macroblock of a frame of an input video (e.g., a macroblock of a frame of input video 101A).

At 152, the process receives a plurality of candidate predicted image blocks that can be used for encoding a macroblock of a frame of an input video. One or more (e.g., each) of the plurality of candidate predicted image blocks has been predicted in accordance with a unique combination of prediction parameters, which can include—for example and without limitation—a prediction mode (i.e., intra-prediction or inter-prediction), a partition mode, a coding mode (e.g., I-frame, P-frame, or B-frame), a skip mode, a reference frame selection, and a strength of one or more filters, e.g., a denoising filter, a sharpening filter, and/or a deblocking filter. In at least one embodiment, the denoising and/or sharpening filters include one or more of a sample adaptive offset (SAO) filter, a deblocking filter, and/or a Weiner filter. At 152, the process also initializes the minimum value Jₘᵢₙ of a joint loss function J by setting Jₘᵢₙ equal to positive infinity.

At 154, the process selects a single candidate predicted image block of the plurality of candidate predicted image blocks received at 152. At 156, the process calculates the value of the joint loss function J for the selected candidate predicted image block. In at least one embodiment, the process calculates the value of the joint loss function J at 156 by (i) computing residuals (i.e., correction values) between the candidate predicted image block and the macroblock of the input corresponding thereto, (iii) transforming the residuals into the frequency domain, (iv) quantizing the transformed residuals, and (v) encoding the quantized transformed residuals. The process then (vi) uses the encoded residuals to measure a distortion and a bit rate corresponding to the encoding of the selected candidate predicted image block and (vii) calculates the value of the joint loss function J.

In at least one embodiment, the joint loss function J is computed according to J=D+(λ_{f}*λ)*R, where D is a value of the distortion measure, R is a value of the bit rate measure, and λ is a static weighting parameter (i.e., a Lagrange multiplier) that controls the relative magnitude of the distortion measure D and the bit rate measure R, and λ_{f} is a dynamically determined λ-factor that is determined based on encoding of prior frames and/or the content of the video to be encoded (e.g., the λ-factor determined by λ-factor agent 104 of FIG. 1A). The product λ_{f}*λ is therefore a dynamically determined weighting parameter that balances rate and distortion in RDO mode selection. In at least one such embodiment, the static weighting parameter λ is determined based on a quantization parameter of an off-the-shelf video codec. For example, in at least one embodiment, the static weighting parameter λ is selected from a fixed table of empirically derived values corresponding to selected quantization parameters of a particular off-the-shelf video codec. In at least one alternative embodiment, the joint loss function/is computed according to J=D+λ_{f}R, where D is a value of the distortion measure, R is a value of the bit rate measure, and λ_{f} is a dynamically determined λ-factor that is determined based on encoding of prior frames and/or the content of the video to be encoded (e.g., the λ-factor determined by λ-factor agent 104 of FIG. 1A). Smaller values of the joint loss function J indicate better quality, because (i) for a constant bit rate lower distortion and therefore lower J indicate better quality, or better compression, and (ii) for a constant distortion a lower bit rate and therefore lower J indicate a smaller file size/reduced network bandwidth.

At 158, the process compares the value of the joint loss function J computed for the selected candidate predicted image block to the stored value of Jₘᵢₙ. If the computed value of J is less than Jₘᵢₙ, then the process updates the value of Jₘᵢₙ at 160, stores an identifier of the selected candidate predicted image block as corresponding to the value of Jₘᵢₙ, and proceeds to 162. If the computed value of J is less than Jₘᵢₙ, then the process proceeds directly to 162. At 162, the process determines whether the candidate predicted image block selected at 154 was a last candidate predicted image block of the plurality of candidate image blocks received at 152. If the process determines, at 162, that additional candidate predicted image blocks remain, the process returns to 154, where an additional candidate predicted image block is selected. Alternatively, if the process determines, at 162, that all candidate predicted image blocks received at 152 have been processed, the process proceeds to 164.

At 164, the process outputs the candidate predicted image block identified as corresponding to Jₘᵢₙ. In this manner, the process compares the compression results achieved with one or more (e.g., each) of the plurality of candidate predicted image blocks and chooses the single candidate predicted image block that provides the best results—by optimizing the joint rate-compression loss function—for the downstream encoding process.

FIG. 2A provides a block diagram of an example system 200, according to an embodiment. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the example system 200 is within the scope and spirit of embodiments of the present disclosure.

System 200 includes neural network 210, encoder 220, memory 230, and processing circuitry 240. Neural network 210 is configured to receive, as input, encoding state information 232 (i.e., corresponding to a previously encoded frame) from memory 230 and to generate, as output, a λ-factor for balancing rate and distortion during video encoding performed by encoder 220. Encoder 220 is configured to receive, as input, a frame of stored video 231 from memory 230 and the λ-factor generated by neural network 210 and to generate, as output, encoding state information 232 (which is stored in memory 230 and which serves as input to neural network 210 for determining a λ-factor for a subsequent frame) and a first encoded frame that is encoded using the λ-factor generated by neural network 210. In at least one embodiment, encoder 220 is further configured to generate, as output, a second encoded frame that is encoded without using the λ-factor generated by the neural network. Processing circuitry 240 is configured to receive one or more of encoded frames 233, to compute, based on one or more of the encoded frames (and, in at least one embodiment, also based on the stored video 231), performance metrics 234. Processing circuitry 240 is further configured to calculate, based on the performance metrics 234, a reward for the λ-factor generated by neural network 210 and an accumulated reward 235 accumulated for generating the λ-factors over multiple frames. Processing circuitry 240 is additionally configured to determine updated network parameters 236 based on the accumulated reward 235 and to update the parameters of neural network 210 accordingly. In at least one embodiment, processing circuitry 240 is configured to carry out a PPO algorithm for updating the parameters of the neural network 210.

FIG. 2B is a flow diagram illustrating a process 250 for training a neural network (e.g., λ-factor agent 104 of FIG. 1A), using reinforcement learning, to dynamically determine a λ-factor for modifying a weighting factor that balances rate and distortion during video encoding. Each block of process 250, described herein, comprises a computing process that may be performed using any combination of hardware, firmware, and/or software. For instance, various functions may be carried out by a processor executing instructions stored in memory. The process may also be embodied as computer-usable instructions stored on computer storage media. The process may be provided by a standalone application, a service or hosted service (standalone or in combination with another hosted service), or a plug-in to another product, to name a few. In addition, process 250 is described, by way of example, with respect to the system of FIG. 2A. However, this process may additionally or alternatively be executed by any one system, or any combination of systems, including, but not limited to, those described herein. Furthermore, persons of ordinary skill in the art will understand that any system that performs process 250 is within the scope and spirit of embodiments of the present disclosure.

Process 250 receives a batch of video frames to be encoded (e.g., a batch of video frames that make up a video clip) and encodes the video frames on a frame-by-frame basis. At 251, process 250 receives a video frame to be encoded. At 252, the neural network (e.g., λ-factor agent 104 of FIG. 1A) determines, based on information corresponding to the encoding of prior video frames, a λ-factor for modifying a weighting factor that balances rate and distortion during video encoding. At 254, an encoder (e.g., an encoder formed by predictor 102, RDO mode selector 106, corrector 108, and residual encoder 110 of FIG. 1A) encodes the video frame to be encoded by using the λ-factor determined at 252 (e.g., by selecting prediction parameters using the process of FIG. 1B). At 256, the process outputs an encoding performance metric (e.g., a PSNR value for the encoding of the video frame to be encoded using the λ-factor). At 258, the process outputs state information (e.g., frame statistics, mode selection information, prediction parameters etc.) corresponding to the encoding of the video frame to be encoded (which is provided to the neural network for use in determining the λ-factor for subsequent iterations).

At 260, an encoder (e.g., the encoder formed by predictor 102, RDO mode selector 106, corrector 108, and residual encoder 110 of FIG. 1A) encodes the video frame to be encoded using a static weighting parameter/(e.g., an empirically derived value) that balances rate and distortion during video encoding. In at least one such embodiment, the static weighting parameter λ is determined based on a quantization parameter of an off-the-shelf video codec. For example, in at least one embodiment, the static weighting parameter λ is selected from a fixed table of empirically derived values corresponding to selected quantization parameters of a particular off-the-shelf video codec. At 262 the process outputs an encoding performance metric (e.g., a PSNR value for the encoding using the static value for the weighting factor). At 264, the process computes a reward based on the encoding performance metrics received at 256 and 262. In at least one embodiment, the reward is computed using an advantage function that provides a measure of the relative improvement achieved via encoding performed using the λ-factor determined at 252. At 266, the process updates an accumulated reward by adding the reward computed at 264 to rewards computed for the encoding of prior video frames of the batch of video frames. At 268, the process determines whether additional frames remain in the batch. The process repeats until all frames in the batch have been encoded, after which, at 270, the process updates the parameters of the neural network. The entire process can then be repeated with a new batch of video frames to be encoded (e.g., a new video clip) to further refine the parameters of the neural network.

FIG. 3 is a block diagram illustrating a reinforcement learning framework for training agent 302, provided in the form of a neural network (e.g., λ-factor agent 104 of FIG. 1A), to dynamically determine a λ-factor for modifying a weighting factor that balances rate and distortion during video encoding. In at least one embodiment, the trained neural network includes one or more layers of Long Short-Term Memory (LSTM) units. In at least one embodiment, the trained neural network consists of 3 layers of LSTM units, each including 64 neurons. LSTM units are capable of capturing temporal dependencies and therefore suitable for video data, which includes temporal sequences of frames.

In the reinforcement learning framework illustrated in FIG. 3, the λ-factor determined by agent 302 (i.e., the action Aₜ chosen by the agent) is communicated to environment 304, provided in the form of a video encoder), which encodes a frame using the λ-factor and provides feedback to the agent in the form of a state Sₜ (e.g., frame statistics, mode selection information, prediction parameters etc. —as described at 208 of FIG. 2A) and a reward Rₜ (e.g., a PSNR). In at least one embodiment, the neural network is trained via proximal policy optimization (PPO). Therefore, in the reinforcement learning framework illustrated in FIG. 3, agent 302 is responsible for predicting a λ-factor and transmitting it to the environment 304 (i.e., the encoder). In at least one embodiment, the λ-factor is transmitted to the encoder via inter-process communication (IPC), which serves as a bridge between the agent 302 and the encoder. Environment 304 receives the λ-factor and uses it to encode a frame, after which it generates and returns feedback to agent 302 in the form of State Sₜ. In at least one embodiment, the State Sₜ includes, e.g., frame statistics and training progress. Environment 304 also returns a reward Rₜ, which—in at least one embodiment—is measured as distortion in terms of Peak Signal-to-Noise Ratio (PSNR). The feedback loop provided by the reinforcement learning framework is crucial as it allows agent 302 to update its internal state based on the received information, thereby facilitating continuous learning and adaptation. The entire process is encapsulated in a feedback loop where the predictions of agent 302 are refined over time, leading to improved encoding performance.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

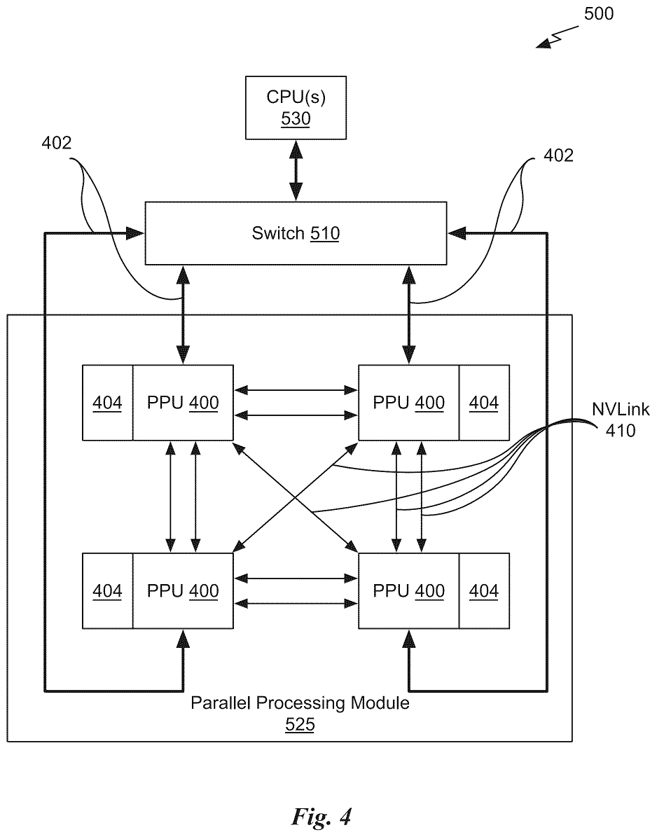

FIG. 4 is a conceptual diagram of a processing system 500 implemented using multiple PPUs 400, in accordance with an embodiment. The exemplary system 500 may utilized as a particular node—or portion thereof—in the above-described multi-node computing systems. In addition to the multiple PPUs 400, the processing system 500 includes a CPU 530, switch 510, and respective memories 404 for the PPUs 400.

Each parallel processing unit (PPU) 400 may include hundreds or thousands of cores that are capable of handling hundreds or thousands of software threads simultaneously. The PPUs 400 may generate pixel data for output images in response to rendering commands (e.g., rendering commands from the CPU(s) 530 received via a host interface). The PPUs 400 may include graphics memory, such as display memory, for storing pixel data or any other suitable data, such as GPU data. The display memory may be included as part of the memory 404. The PPUs 400 may include two or more GPUs operating in parallel (e.g., via a link). The link may directly connect the GPUs (e.g., using NVLINK 410) or may connect the GPUs through a switch (e.g., using switch 510). When combined together, each PPU 400 may generate pixel data or GPGPU data for different portions of an output or for different outputs (e.g., a first PPU for a first image and a second PPU for a second image). Each PPU 400 may include its own memory 404, or may share memory with other PPUs 400.

The PPUs 400 may each include, and/or be configured to perform functions of, one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 410 provides high-speed communication links between each of the PPUs 400. Although a particular number of NVLink 410 and interconnect 402 connections are illustrated in FIG. 4, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 4, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 4, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

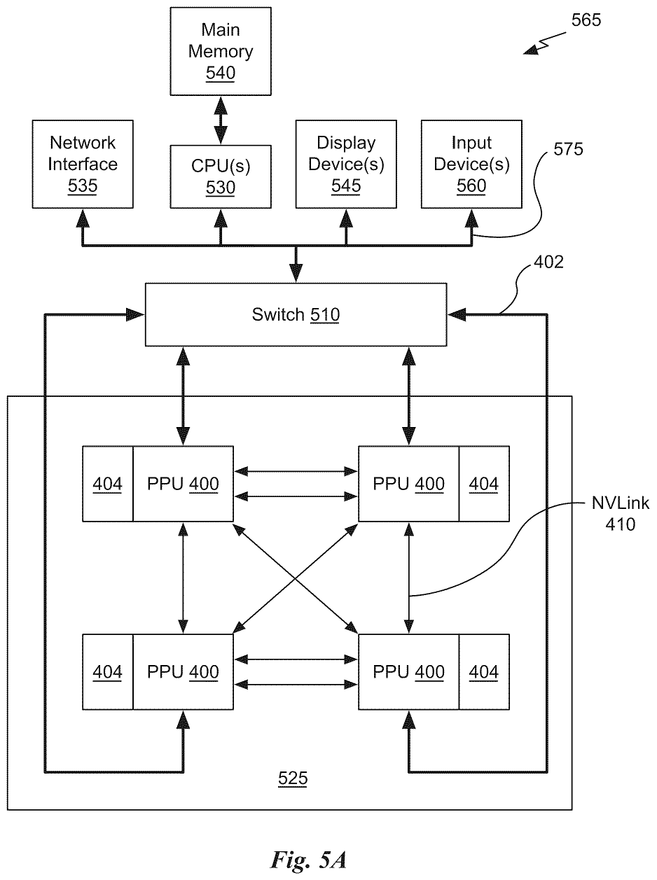

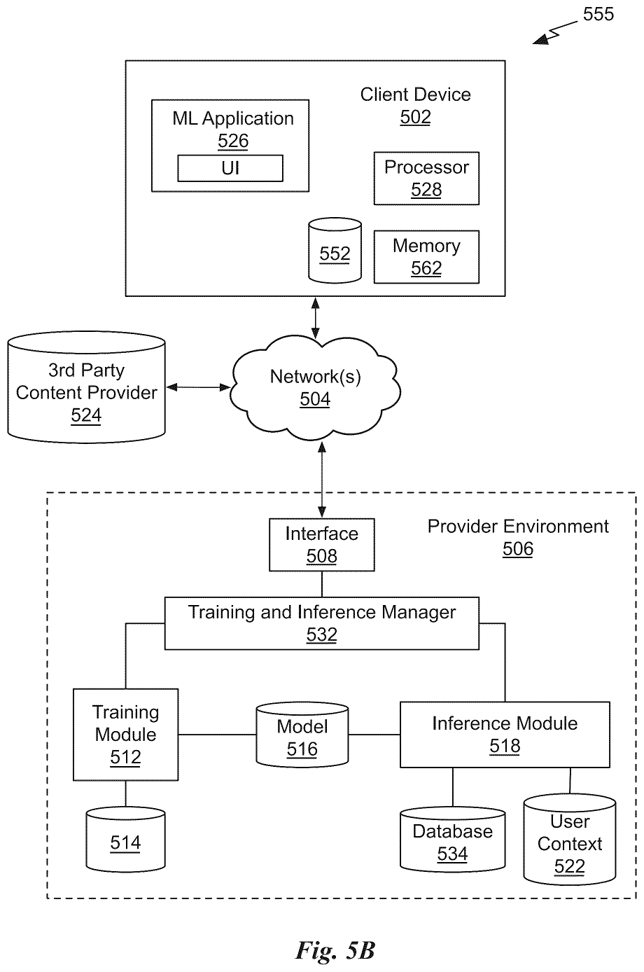

FIG. 5A illustrates an exemplary system 565 in which the various architecture and/or functionality of the various previous embodiments may be implemented. The exemplary system 565 may be configured to implement the method 300 shown in FIG. 3.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5A are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5A is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5A.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 4 and/or exemplary system 565 of FIG. 5A—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 4 and/or exemplary system 565 of FIG. 5A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5B illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506. In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

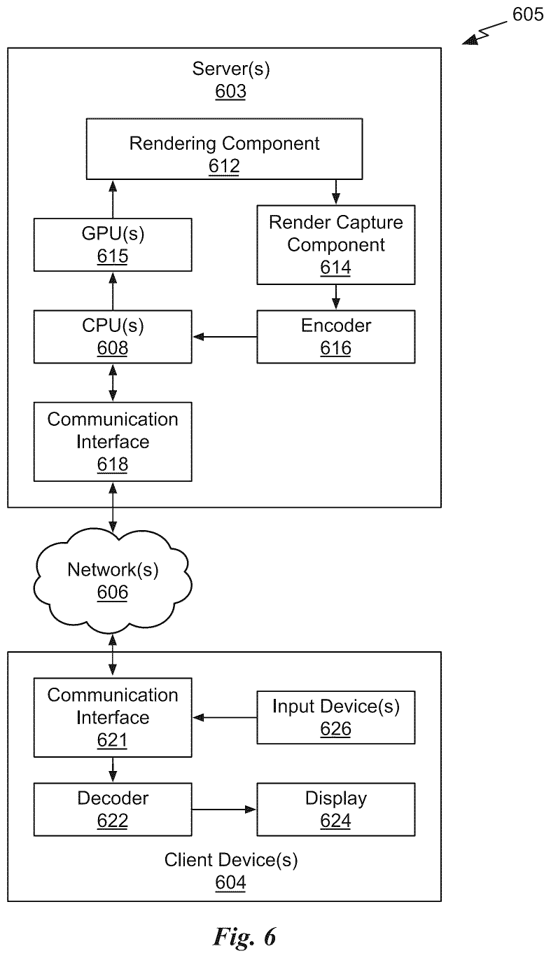

FIG. 6 is an example system diagram for a streaming system 605, in accordance with some embodiments of the present disclosure. FIG. 6 includes server(s) 603 (which may include similar components, features, and/or functionality to the example processing system 500 of FIG. 4 and/or exemplary system 565 of FIG. 5A), client device(s) 604 (which may include similar components, features, and/or functionality to the example processing system 500 of FIG. 4 and/or exemplary system 565 of FIG. 5A), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A method for encoding a video, the method comprising:
determining a weighting parameter for a frame of the video by a trained reinforcement learning (RL) agent, the weighting parameter being determined based on encoding of one or more prior frames of the video;
generating, for a reference block of a frame of the video, a plurality of candidate predicted blocks; and
selecting, using rate-distortion optimization (RDO) based on the determined weighting parameter, a predicted block from the plurality of candidate predicted blocks.

2. The method according to claim 1, further comprising:
computing, using the selected predicted block and the reference block, one or more residuals; and
encoding the one or more residuals in a codestream.

3. The method according to claim 1, wherein the RDO uses the determined weighting parameter to balance one or more rate and distortion components of a joint loss function, and wherein the joint loss function is represented using at least one of:
J=D+(λ_{f}*λ)*R, where D represents distortion, R represents rate, λ_{f} is the weighting parameter determined by the trained RL agent, and λ is an empirically determined Lagrange multiplier, or
J=D+λ_{f}R, where D represents distortion, R represents rate, and λ_{f} is the weighting parameter determined by the trained RL agent.

4. The method according to claim 1, wherein the results of encoding one or more prior frames of the video comprise encoding statistics corresponding to the encoding of one or more previously encoded video frames.

5. The method according to claim 4, wherein the encoding statistics include one or more of:
a bitstream size,
an average Quantization Parameter (QP) value for one or more frames,
a count of intra-coded macroblocks,
a count of inter-coded macroblocks,
a number of slices,
a picture type,
a Sum of Absolute Transformed Differences (SATD) for one or more frames,
an average Motion Vector (MV) x-component,
an average Motion Vector (MV) y-component,
a count of 32×32 coding units (CUs) encoded using intra-prediction,
a count of 32×32 CUs encoded using inter-prediction,
a count of 16×16 CUs encoded using intra-prediction, or
a count of 16×16 CUs encoded using inter-prediction.

6. The method according to claim 1, wherein the trained RL agent is a trained neural network comprising one or more layers of Long Short-Term Memory (LSTM) units.

7. The method according to claim 1, wherein the trained RL agent is a neural network trained via proximal policy optimization (PPO).

8. The method according to claim 1, wherein the RL agent is a neural network trained, via reinforcement learning, to maximize a reward based on encoding performance.

9. The method according to claim 8, wherein the reward is computed using an advantage function that measures an advantage achieved by encoding the frame using the weighting parameter as compared to encoding the frame without using the weighting parameter.

10. The method according to claim 1, wherein the plurality of candidate predicted blocks are generated by an intra-frame predictor and an inter-frame predictor,
wherein at least one of the plurality of candidate predicted blocks is predicted in accordance with a combination of or more prediction parameters, and
wherein the combination of one or more prediction parameters include at least one of: a prediction mode, a partition mode, a coding mode, a skip mode, a reference frame selection, a chroma subsampling mode, or a strength of one or more filters.

11. The method according to claim 1, wherein the encoding is performed using a standards-compliant video codec selected from the group of video codec standards consisting of: VP8, VP9, AVC (h.264), HEVC (h.265), AV1, AV2, or VVC (h.266).

12. A system for encoding a video, the system comprising:
processing circuitry configured to:
determine a weighting parameter for a frame of the video by a trained reinforcement learning (RL) agent, the weighting parameter being determined based on results of encoding of one or more prior frames of the video;
generate, for a reference block of a frame of the video, a plurality of candidate predicted blocks; and
select, using rate-distortion optimization (RDO) based on the determined weighting parameter, a predicted block from the plurality of candidate predicted blocks; and
memory configured to store the frame and the plurality of candidate predicted blocks.

13. The system according to claim 12, wherein the processing circuitry is further configured to:
compute, using the selected predicted block and the reference block, one or more residuals; and
encode the one or more residuals in a codestream.

14. The system according to claim 12, wherein the RDO uses the determined weighting parameter to balance one or more rate and distortion components of a joint loss function, and wherein the joint loss function is represented using at least one of:
J=D+(λ_{f}*λ)*R, where D represents distortion, R represents rate, λ_{f} is the weighting parameter determined by the trained RL agent, and λ is an empirically determined Lagrange multiplier, or
J=D+λ_{f}R, where D represents distortion, R represents rate, and λ_{f} is the weighting parameter determined by the trained RL agent.

15. The system according to claim 12, wherein the results of encoding one or more prior frames of the video comprise encoding statistics corresponding to the encoding of one or more previously encoded video frames.

16. The system according to claim 15, wherein the encoding statistics include one or more of:
a bitstream size,
an average Quantization Parameter (QP) value for one or more frames,
a count of intra-coded macroblocks,
a count of inter-coded macroblocks,
a number of slices,
a picture type,
a Sum of Absolute Transformed Differences (SATD) for one or more frames,
an average Motion Vector (MV) x-component,
an average Motion Vector (MV) y-component,
a count of 32×32 coding units (CUs) encoded using intra-prediction,
a count of 32×32 CUs encoded using inter-prediction,
a count of 16×16 CUs encoded using intra-prediction, or
a count of 16×16 CUs encoded using inter-prediction.

17. The system according to claim 12, wherein the trained RL agent is a neural network comprising one or more layers of Long Short-Term Memory (LSTM) units and trained, via reinforcement learning, to maximize a reward based on encoding performance.

18. The system according to claim 17, wherein the reward is computed using an advantage function that measures an advantage achieved by encoding the frame using the weighting parameter as compared to encoding the frame without using the weighting parameter.

19. A system comprising:
one or more processing units to:
determine a weighting parameter for a frame of a video, the weighting parameter being determined based on results of encoding of one or more prior frames of the video,
generate, for a reference block of a frame of the video, a plurality of candidate predicted blocks, and
select, using rate-distortion optimization (RDO) based on the determined weighting parameter, a predicted block from the plurality of candidate predicted blocks.

20. The system of claim 19, wherein the one or more processing units are included in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system for performing generative AI operations;
a system implemented using one or more large language model (LLMs),
a system implemented using one or more vision language model (VLMs);
a collaborative content creation platform for 3D assets; or
a system implemented at least partially using cloud computing resources.
